(19) United States
(12) Patent Application Publication
(10) Pub. No.: US 2016/0027127 A1
(43) Pub. Date: Jan. 28, 2016

(54) METHOD AND SYSTEM FOR INFERRING TAXPAYER LOCATION FROM TRANSACTION DATA

(71) Applicant: MasterCard International Incorporated, Purchase, NY (US)

(72) Inventors: Pedro J. Chavarria, New York, NY (US); Kristofer Perez, New York, NY (US)

(21) Appl. No.: 14/341,996

(22) Filed: Jul. 28, 2014

(51) Int. Cl. G06Q 40/00; G06Q 20/38

(52) U.S. Cl. CPC G06Q 40/123; G06Q 20/38

(57) ABSTRACT

A computer-implemented method for inferring a taxpayer location from transaction data is implemented by a computing device coupled to a memory. The method includes receiving, by the computing device, a travel report request message including a payment card identifier associated with a taxpayer and a report date, retrieving, by the computing device, transaction data for a payment card associated with the payment card identifier and the report date, the transaction data including merchant location data associated with a merchant zip code, inferring a location of the taxpayer using the merchant location and the report date, comparing the inferred location with a plurality of tax zones stored in the memory to determine a specific tax zone of the plurality of tax zones associated with the inferred location of the taxpayer, and providing a travel report to the taxpayer, wherein the travel report includes the inferred location for the report date and the tax zone associated with the inferred location.

### BACKGROUND OF THE DISCLOSURE

The field of the disclosure relates generally to processing payment transactions initiated with a payment card over a payment network, and more particularly, to systems and methods for inferring taxpayer location from transaction data associated with a payment transaction initiated with a payment card over a payment network.

Annual tax preparation is a necessary task and may be complicated for persons who travel regularly as part of their job. Different countries and states may have different tax implications (e.g., tax rate) for persons that travel regularly. Accordingly, persons who travel regularly for work may be required to declare time spent working in each location for tax reporting purposes. For example, a person lives and works in one state but travels to another state on business several times throughout the year. The person may then be subject to the tax implications of the other state based on the amount of time spent in that state on business travel.

People that travel oftentimes use payment cards to pay for their travel expenses. Cardholders (e.g., people/entities using a payment card such as a credit card, a debit card, or a prepaid card) will initiate transactions with merchants such as travel agents, airlines, car services, hotels, restaurants, etc. In some cases, people that travel for business purposes use payment cards that are specially designated for business travel. For example, some business travelers will carry a corporate payment card or some other payment card that is primarily, if not exclusively, used for their business expenses.

Transaction data associated with these payment transactions is generated and received by the payment network for processing the payment transactions. The transaction data includes, among other data points, location data for the merchant involved in the transaction. The location data may include country information, city information, state information, address information, and zip code information. The location data may also include whether the merchant is an actual brick-and-mortar store or an online merchant. It would be beneficial to provide the taxpayer with a summary of locations travelled and time spent at each location for tax preparation and/or reporting purposes.

### BRIEF DESCRIPTION OF THE DISCLOSURE

In one aspect, a computer-implemented method for inferring a taxpayer location from transaction data is provided. The method is implemented by a computing device coupled to a memory. The method includes receiving, by the computing device, a travel report request message including a payment card identifier associated with a taxpayer and a report date, retrieving, by the computing device, transaction data for a payment card associated with the payment card identifier and the report date, the transaction data including merchant location data associated with a merchant zip code, inferring a location of the taxpayer using the merchant location and the report date, comparing the inferred location with a plurality of tax zones stored in the memory to determine a specific tax zone of the plurality of tax zones associated with the inferred location of the taxpayer, and providing a travel report to the taxpayer, wherein the travel report includes the inferred location for the report date and the tax zone associated with the inferred location.

In another aspect, a computing device for inferring a taxpayer location from transaction data is provided. The computing device includes a processor and a memory coupled to the processor. The computing device is configured to receive a travel report request message including a payment card identifier associated with a taxpayer and a report date, retrieve transaction data for a payment card associated with the payment card identifier and the report date, the transaction data including merchant location data associated with a merchant zip code, infer a location of the taxpayer using the merchant location and the report date, compare the inferred location with a plurality of tax zones stored in the memory to determine a specific tax zone of the plurality of tax zones associated with the inferred location of the taxpayer, and provide a travel report to the taxpayer, wherein the travel report includes the inferred location for the report date and the tax zone associated with the inferred location.

In a further aspect, computer-readable storage media for inferring a taxpayer location from transaction data is provided. The computer-readable storage media has computer-executable instructions embodied thereon. When executed by at least one processor, the computer-executable instructions cause the processor to receive a travel report request message including a payment card identifier associated with a taxpayer and a report date, retrieve transaction data for a payment card associated with the payment card identifier and the report date, the transaction data including merchant location data associated with a merchant zip code; infer a location of the taxpayer using the merchant location and the report date, compare the inferred location with a plurality of tax zones to determine a specific tax zone of the plurality of tax zones associated with the inferred location of the taxpayer, and provide a travel report to the taxpayer, wherein the travel report includes the inferred location for the report date and the tax zone associated with the inferred location.

### BRIEF DESCRIPTION OF THE DRAWINGS

The figures listed below show example embodiments of the methods and systems described herein.

FIGS. 1-7 show example embodiments of the methods and systems described herein.

FIG. 1 is a schematic diagram illustrating an example multi-party transaction card industry system for enabling ordinary payment-by-card transactions in which merchants and card issuers do not need to have a one-to-one special relationship.

FIG. 2 is an expanded block diagram of an example embodiment of server architecture used in payment transactions in accordance with one example embodiment of the present disclosure.

FIG. 3 illustrates an example configuration of a user computing device 302 in accordance with one embodiment of the present disclosure.

FIG. 4 illustrates an example configuration of a server system such as the online merchant shown in FIG. 1, configured to interact with the mobile computing device of FIG. 3.

FIG. 5 is a simplified data flow diagram of an example computing device inferring a taxpayer location from transaction data.

FIG. 6 is a simplified diagram of an example method of providing cardholder account information to facilitate a payment transaction.

FIG. 7 is a diagram of components of one or more example computing devices that may be used in the environment shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

Described herein are computer systems such as mobile computing devices, online merchant servers, payment network servers, and issuing bank servers. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memory devices wherein the memory devices may be in one computing device or a plurality of computing devices acting in parallel.

As used herein, “financial transactions” refers to any transaction of currency, electronic currency, assets, or anything else of value in exchange for goods, services or other currency or assets. More specifically, as used herein, financial transactions may refer to payment transactions wherein a user such as a cardholder provides currency or electronic currency in exchange for goods or services. In at least one example, such financial transactions may include a cardholder interacting with a merchant over an electronic commerce site or an electronic commerce application in order to purchase goods or services. In at least this example, financial transactions may also be referred to as commercial transactions initiated at the merchant's brick and mortar location.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The subject matter described herein relates generally to reporting transaction data, and more particularly, to systems and methods for inferring a taxpayer location over a predetermined period of time from the transaction data. Specifically, the methods and systems described herein include (i) receiving, by the computing device, a travel report request message including a payment card identifier associated with a taxpayer and a report date; (ii) retrieving, by the computing device, transaction data for a payment card associated with the payment card identifier and the report date, the transaction data including merchant location data associated with a merchant zip code; (iii) inferring a location of the taxpayer using the merchant location and the report date; (iv) comparing the inferred location with a plurality of tax zones to determine a specific tax zone of the plurality of tax zones associated with the inferred location of the taxpayer; and (v) providing a travel report to the taxpayer, wherein the travel report includes the inferred location for the report date and the tax zone associated with the inferred location.

The systems and methods described herein facilitate inferring a taxpayer location by summarizing transactions with merchants initiated by the cardholder traveling to different locations during a period of time. Using the transaction summary is beneficial for tax preparation and/or reporting purposes. Further, as described herein, using the transaction summary allows for tracking specific tax zones visited by the cardholder during specific time periods to facilitate recording and/or reporting expenses incurred for each tax zone which may have a unique tax rate.

In some examples, a cardholder may travel regularly, for business purposes and/or for personal purposes, to different geographic locations such as different states during a specific time period. Different geographical locations may have unique tax implications (beneficial or adverse). The cardholder may be subject to the different tax implications of a particular state based on the amount of time spent by the cardholder in the particular state. In some instances, the cardholder compensation and/or expenses may be analyzed for tax purposes based on the time spent in particular locations. Accordingly, methods and system for inferring taxpayer locations during specific time periods are desirable for tax preparation and/or reporting purposes.

As described herein, an example computing device is used to infer a taxpayer location during specific time periods for tax preparation and/or reporting purposes. In one example, a purchase transaction is conducted between a cardholder and a merchant. After a purchase has been made, a clearing process occurs to transfer additional transaction data related to the purchase among the parties to the transaction, such as merchant bank, interchange network, and issuer bank. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. The transaction data includes merchant location data associated with a merchant zip code. In some examples, the computing device may compare the merchant location to a tax zone. Moreover, the computing device may generate a travel report associated with merchant location during a period of time.

In the example system described herein, the payment network (a/k/a the payment computing system) includes a travel reporting service that provides a cardholder with business-related travel data including a determined number of days spent at various locations through the year that can be used by the cardholder for tax preparation and/or reporting purposes. The example system includes a payment computing device that includes a travel reporting component configured to determine the business-related travel data (e.g., merchant locations and transaction dates) from the transaction data of the traveler/cardholder, and compares the determined locations to a list of tax zones stored within the system, wherein each tax zone is associated with a government tax rate.

The travel reporting component is in communication with the payment network, and is configured to (i) retrieve transaction data for transactions involving a cardholder during a specified time period (e.g., one year), (ii) determine (or infer) a time and a location associated with each transaction, (iii) determine an estimated location of the cardholder for each day of the specified time period using the time and the location for each transaction, (iv) compare the estimated location with a plurality of tax zones to determine which tax zone the cardholder is located in for each day of the specified time period, and (v) provide to the cardholder a travel summary report identifying an amount of time spent in the determined tax zone for each day of the specified time period. The travel reporting component, as described herein, retrieves transaction data for transactions involving a cardholder only after the cardholder, and any other authorized party, provides, or has previously provided, authorization for the travel reporting component to access the data. The cardholder provides such authorization by registering with the reporting component or by opting in to the reporting service. The system is not configured to provide the transaction data, the inferred location data, and/or the travel summary to an actual governmental taxing entity. Rather, it provides the report to the cardholder for his/her use.

The system described herein enables a cardholder to submit a travel report request message that includes a cardholder identifier, an account identifier (e.g., a PAN), and a report period (e.g., one year). If the cardholder has registered with the system, the system retrieves transaction data for one or more transactions involving the cardholder for the report period based on the information contained within the request message. For each transaction, the transaction data includes at least merchant location data and a transaction date. In one embodiment, the transaction data may further include information identifying airline, hotel, and other travel related details. In another embodiment, the transaction data may be retrieved then stored in a cardholder location database in communication with the system.

The system then determines an inferred location of the cardholder for each day of the report period. The inferred location is a zip code location of the cardholder, and is determined using the merchant zip code and the transaction date. More specifically, the system determines the inferred location for each day in the report period using the merchant zip code for each transaction having the same transaction date. For example, the inferred location may be a zip code location corresponding to the merchant zip code appearing more frequently in transactions for each day.

The system then determines a tax zone associated with the inferred location of the cardholder for each day of the report period. The tax zone may include one or more of a zip code, a city, a county, or other geography. In the example embodiment, the system compares the inferred location of the cardholder for each day of the report period with a plurality of tax zones stored in a memory. Based on the comparison, a selected tax zone of the plurality of tax zones is associated with the inferred location (e.g., when the inferred location is a zip code located within the tax zone).

The system then provides a summary report to the cardholder including the inferred location and the tax zone for each day of the report period. The cardholder may also be provided one or more options to control how the information is portrayed (e.g., in a calendar, list, etc.). For example, the summary report may be a calendar with colored highlighting to indicate days spent in various tax zones, where each color represents a different tax zone. The summary report may also include values representing the total number of days spent in each tax zone during the summary period.

In one embodiment, the system may also determine whether the inferred location is associated with personal travel or business travel. This association may be used when determining the tax zone associated with the inferred location and may also be included in the summary report. The system may determine the inferred location as being associated with personal travel or business travel based on the type of card involved in each transaction (e.g., personal card or corporate card), the type of merchant involved in each transaction, the location of merchants involved in each transaction (e.g., relative to the cardholder's home location), or other suitable means. For example, the system may determine the inferred location as being associated with business travel for transactions involving a corporate card. The system may also determine the inferred location as being associated with business travel for transactions involving a merchant located away from the cardholder's home, or when the merchant type includes a hotel, an airport, a restaurant, or other similar merchant type. For transactions involving a personal card, transactions involving merchants located near the cardholder's home, or transactions involving merchant types usually associated with vacation travel (e.g., casinos, resorts, etc.), the system may determine the inferred location as being associated with personal travel.

In another embodiment, the system may determine the inferred location of the cardholder using an application on a mobile device of the cardholder. More specifically, the system may use an application on the mobile device of the cardholder to validate the inferred location determined using the transaction data. For example, to validate the inferred location, the system may compare the inferred location with a GPS location of the cardholder acquired using the application. The system may also validate the inferred location by comparing the inferred location with historical location information stored, or accessible, by the application.

In other embodiments, the travel application is configured to receive supplemental data from the cardholder. Supplemental data may include, but is not limited to, additional transactions that occurred during travel. For example, the cardholder may enter additional transactions where the cardholder paid with cash, check, or a different payment card. In these other embodiments, the travel application is configured to utilize this supplemental data in creating the travel report and inferring the location of the cardholder.

In additional embodiments, the travel application is configured to receive data from cardholder's social media network. The travel application gathers location data from a check-in or other location identifying action on a social media network and stores that data. In these additional embodiments, the travel application is configured to utilize this location data in creating the travel report and inferring the location of the cardholder.

In some embodiments, system stores travel data without including sensitive personal information, also known as personally identifiable information or PII, in order to ensure the privacy of individuals associated with the stored data. Personally identifiable information may include any information capable of identifying an individual. For privacy and security reasons, personally identifiable information may be withheld from the cardholder profiles. In some examples where privacy and security, such as through encryption, can otherwise be ensured, or where individuals consent, personally identifiable information may be retained in the cardholder profiles. In such examples, personally identifiable information may be needed to reports about groups of cardholders. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed. For example, an individual's identity may be processed so that no personally identifiable information can be determined for the individual, or an individual's geographic location may be generalized where location data is obtained (such as to a city, ZIP code, or state level), so that a particular location of an individual cannot be determined. Thus, the individual may have control over how information is collected about the individual and used by systems including the travel application.

A technical effect of the systems and methods described herein include at least one of (a) a secure method of tracking transaction data based on merchant locations during a particular time period; (b) inferring a cardholder's location during specific time periods; (c) compiling cardholder locations for tax preparation purposes, and (d) providing, upon request by cardholder, a travel summary report.

More specifically, the technical effects can be achieved by performing at least one of the following steps: (a) receiving by a computing device a travel report request message including a payment card identifier associated with a taxpayer and a report date; (b) retrieving by the computing device transaction data for a payment card associated with the payment card identifier and the report date, the transaction data including merchant location data associated with a merchant zip code; (c) inferring a location of the taxpayer using the merchant location and the report date; (d) comparing the inferred location with a plurality of tax zones to determine a specific tax zone of the plurality of tax zones associated with the inferred location of the taxpayer; (e) providing a travel report to the taxpayer, wherein the travel report includes the inferred location for the report date and the tax zone associated with the inferred location; (f) receiving by the computing device a registration request message including a payment card identifier associated with the taxpayer; (g) storing the travel report on at least one of a local data repository and a cloud-based storage; (h) storing the plurality of cardholder account information on at least one of a local data repository and cloud-based storage; (i) storing tax zone location data for a plurality of tax zones within a memory, wherein each of the plurality of tax zones is associated with at least one of zip code, a city, and a country associated with a merchant; (j) determining a travel type associated with the inferred location, wherein the travel type is at least one of a personal travel and a business travel; (k) providing a travel application on a mobile device of the taxpayer; (l) receiving, by the computing device, a global positioning system location of the taxpayer from the mobile device; (m) receiving, by the computing device, a travel history data from the travel application, wherein the travel data include data associated with an actual location of the taxpayer; (n) gathering location data associated with the taxpayer from a social media network; (o) gathering supplemental travel data not included in transaction data; (p) validating the inferred location of the taxpayer using the actual location of the taxpayer; (q) storing taxpayer data for a plurality of taxpayers within the memory; (r) receiving a taxpayer identifier associated with the taxpayer and determine whether the taxpayer is one of the plurality of registered taxpayers based on the taxpayer identifier; and (s) retrieving the transaction data for a payment card associated with the payment card identifier and the report date when the taxpayer is one of the plurality of registered taxpayers.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

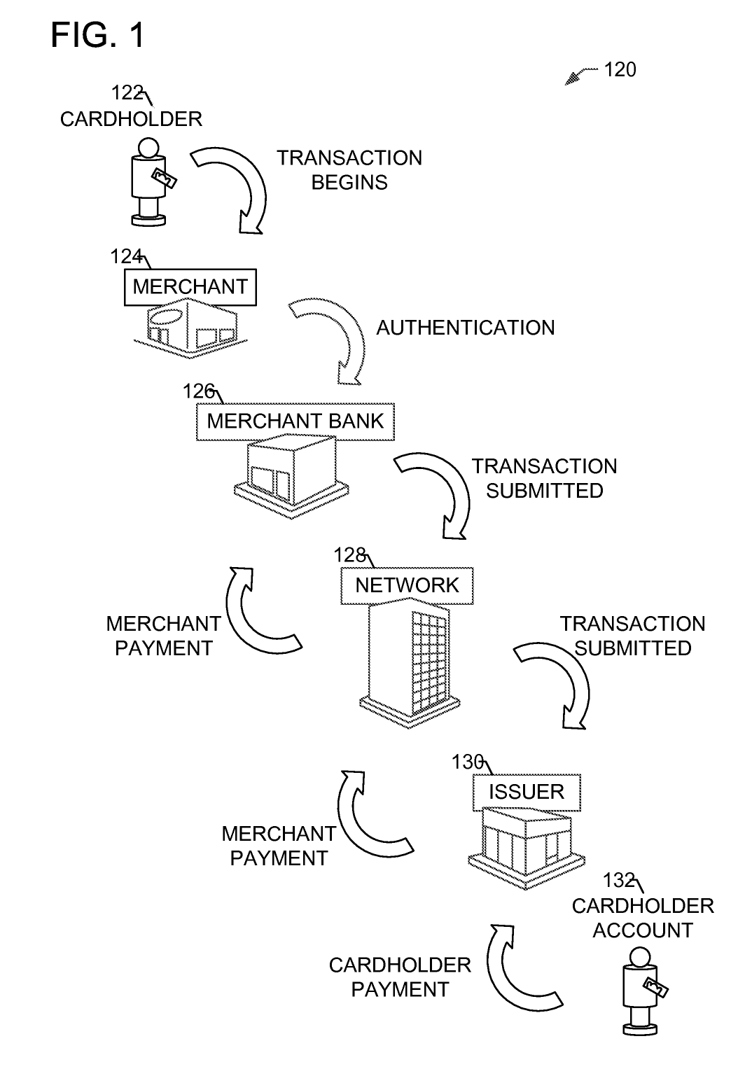

FIG. 1 is a schematic diagram illustrating an example multi-party transaction card industry system 120 for enabling ordinary payment-by-card transactions in which merchants 124 and card issuers 130 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

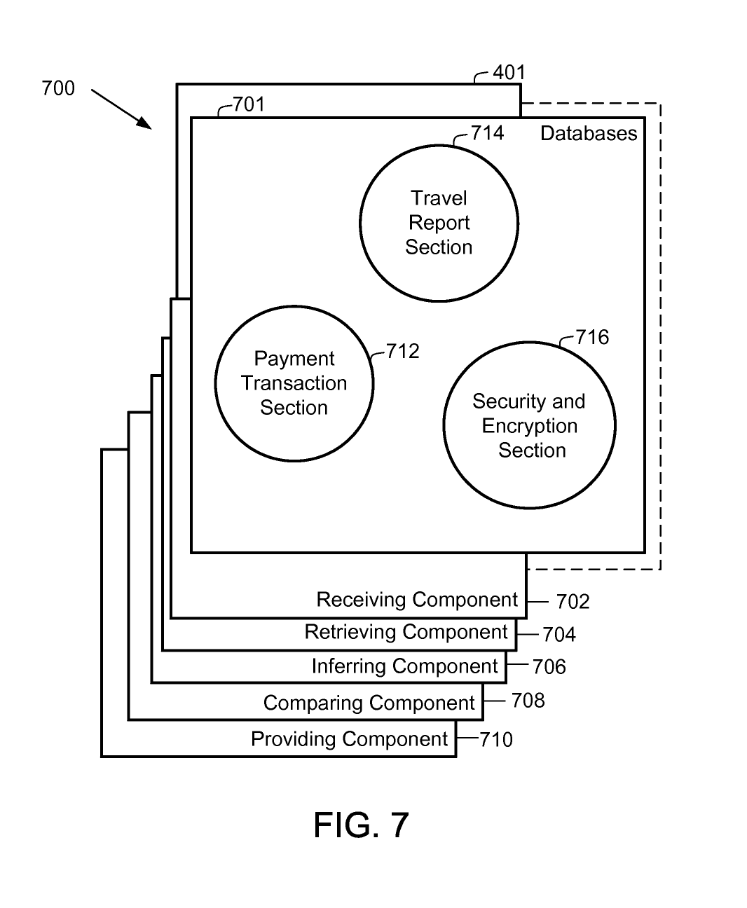

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 701 (shown in FIG. 7).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 701.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

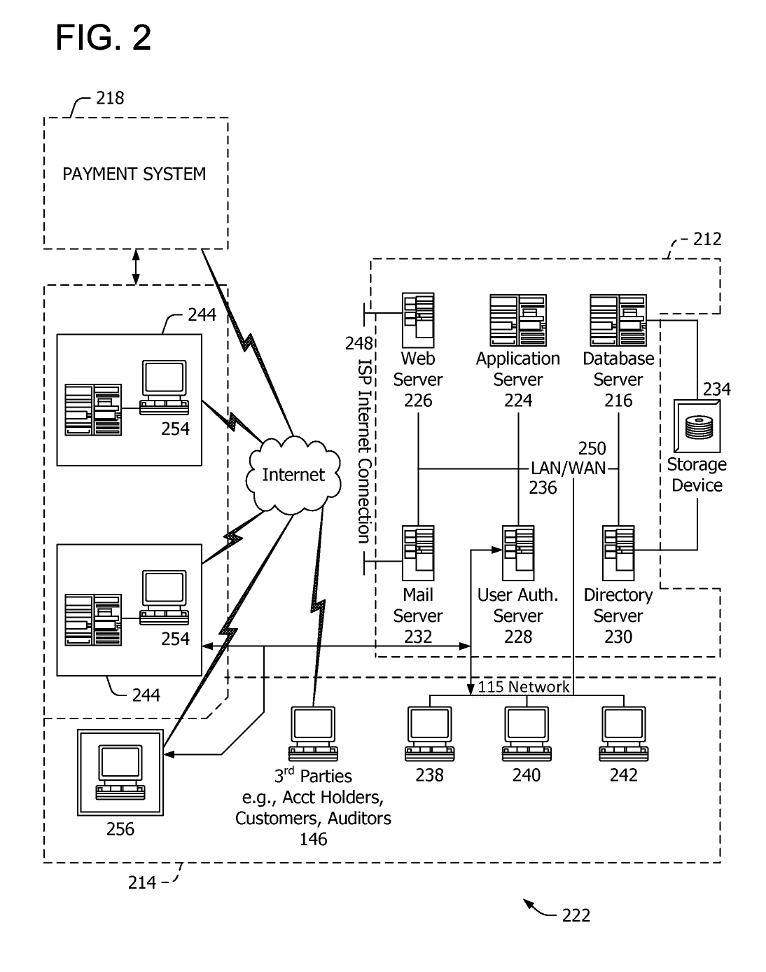

FIG. 2 is an expanded block diagram of an example embodiment of a computer server system architecture 222 used in payment transactions including other computer devices in accordance with one embodiment of the present disclosure. System 222 includes server computer system 212, client systems 214, and payment systems 218. Server computer system 212 further includes database server 216, an application server 224, a web server 226, a user authentication server 228, a directory server 230, and a mail server 232. A storage device 234 is coupled to database server 216 and directory server 230. Servers 216, 224, 226, 228, 230, and 232 are coupled in a local area network (LAN) 236. In addition, an issuer bank workstation 238, an acquirer bank workstation 240, and a third party processor workstation 242 may be coupled to LAN 236. In the example embodiment, issuer bank workstation 238, acquirer bank workstation 240, and third party processor workstation 242 are coupled to LAN 236 using network connection 215. Workstations 238, 240, and 242 are coupled to LAN 236 using an Internet link or are connected through an Intranet.

Each workstation 238, 240, and 242 is a personal computer having a web browser. Although the functions performed at the workstations typically are illustrated as being performed at respective workstations 238, 240, and 242, such functions can be performed at one of many personal computers coupled to LAN 236. Workstations 238, 240, and 242 are illustrated as being associated with separate functions only to facilitate an understanding of the different types of functions that can be performed by individuals having access to LAN 236.

Server computer system 212 is configured to be operated by various individuals including employees 244 and to third parties, e.g., account holders, customers, auditors, developers, consumers, merchants, acquirers, issuers, etc., 246 using an ISP Internet connection 248. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 250, local area network 236 could be used in place of WAN 250. Server computer system 212 is also configured to be communicatively coupled to payment systems 218. Payment systems 218 include computer systems associated with merchant bank 126, interchange network 128, issuer bank 130 (all shown in FIG. 1), and interchange network 128. Additionally, payments systems 218 may include computer systems associated with acquirer banks and processing banks. Accordingly, payment systems 218 are configured to communicate with server computer system 212 and provide transaction data as discussed below.

In the example embodiment, any authorized individual having a workstation 254 can access system 222. At least one of the client systems includes a manager workstation 256 located at a remote location. Workstations 254 and 256 are personal computers having a web browser. Also, workstations 254 and 256 are configured to communicate with server computer system 212.

Also, in the example embodiment, web server 226, application server 224, database server 216, and/or directory server 230 may host web applications, and may run on multiple server systems 212. The term “suite of applications,” as used herein, refers generally to these various web applications running on server systems 212.

Furthermore, user authentication server 228 is configured, in the example embodiment, to provide user authentication services for the suite of applications hosted by web server 226, application server 224, database server 216, and/or directory server 230. User authentication server 228 may communicate with remotely located client systems, including a manager workstation 256. User authentication server 228 may be configured to communicate with other workstations 238, 240, and 242 as well.

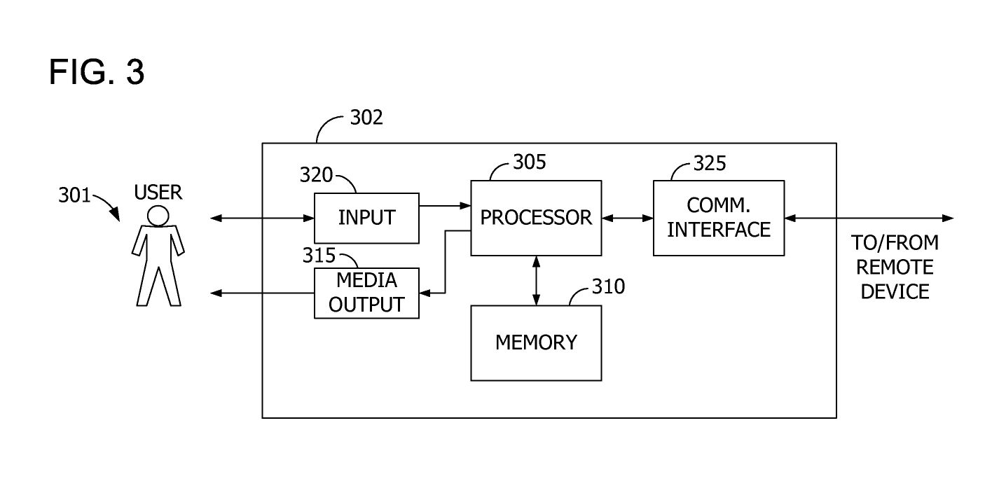

FIG. 3 illustrates an example configuration of a user computing device 302 in accordance with one embodiment of the present disclosure. User computing device 302 may include, but is not limited to, client systems 214, 238, 240, and 242, payment systems 218, workstation 254, and manager workstation 256 (all shown in FIG. 2). In alternative embodiments, user computing device 302 may include, without limitation, a smart phone, a personal digital assistant, a computer tablet, a hybrid phone/computer tablet (“phablet”), or other similar mobile device capable of communicating to the web. In the example embodiment, user computing device 302 also includes a microphone and speakers (not shown) for telephonic communication, recording, and audio playback. In the example embodiment, user computing device 302 includes a processor 305 for executing instructions. In some embodiments, executable instructions are stored in a memory area 310. Processor 305 may include one or more processing units, for example, a multi-core configuration. Memory area 310 is any device allowing information such as executable instructions and/or written works to be stored and retrieved. Memory area 310 may include one or more computer readable media.

User computing device 302 also includes at least one media output component 315 for presenting information to user 301. Media output component 315 is any component capable of conveying information to user 301. In some embodiments, media output component 315 includes an output adapter such as a video adapter and/or an audio adapter. An output adapter is operatively coupled to processor 305 and operatively coupleable to an output device such as a display device, a liquid crystal display (LCD), organic light emitting diode (OLED) display, or “electronic ink” display, or an audio output device, a speaker or headphones.

In some embodiments, user computing device 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 315 and input device 320. User computing device 302 may also include a communication interface 325, which is communicatively coupleable to a remote device. Communication interface 325 may include, for example, a wired or wireless network adapter or a wireless data transceiver for use with a mobile phone network, Global System for Mobile communications (GSM), 3G, 4G or other mobile data network or Worldwide Interoperability for Microwave Access (WIMAX).

Stored in memory area 310 are, for example, computer readable instructions for providing a user interface to user 301 via media output component 315 and, optionally, receiving and processing input from input device 320. A user interface may include, among other possibilities, a web browser and client application. Web browsers enable users, such as user 301, to display and interact with media and other information typically embedded on a web page or a website. A client application allows user 301 to interact with a server application. For example, instructions may be stored by a cloud service, and the output of the execution of the instructions sent to the media output component 315.

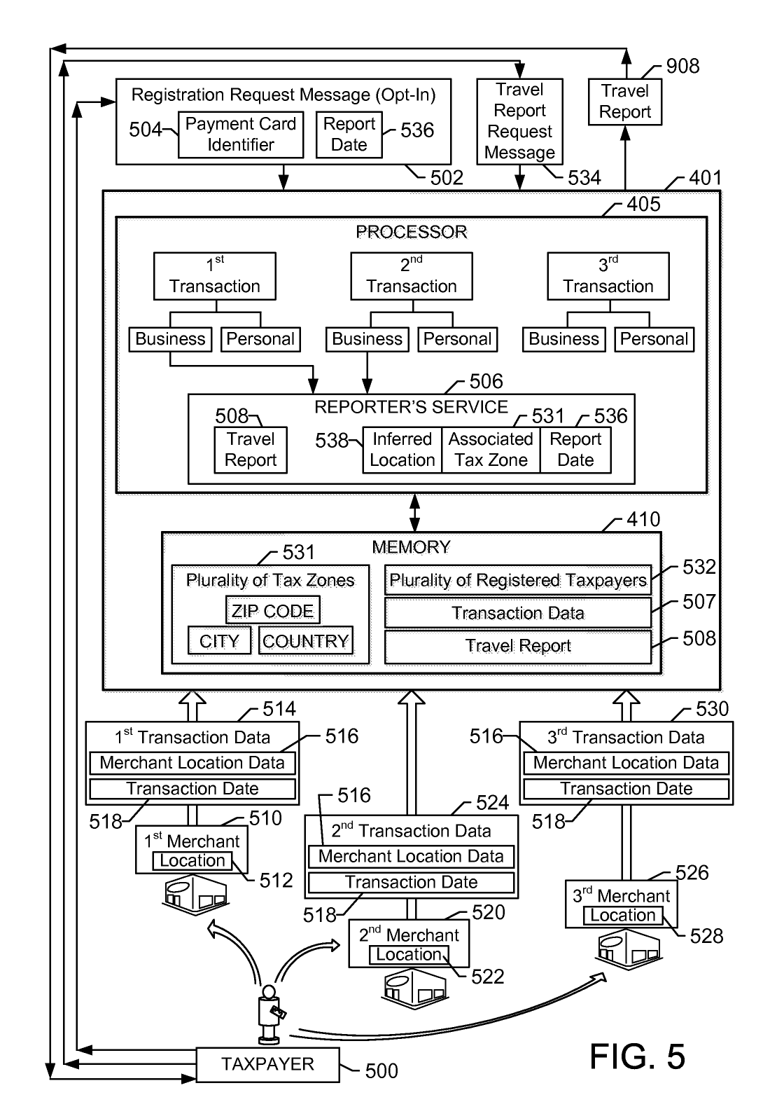

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 is programmed with the instructions, such those as illustrated in FIG. 5.

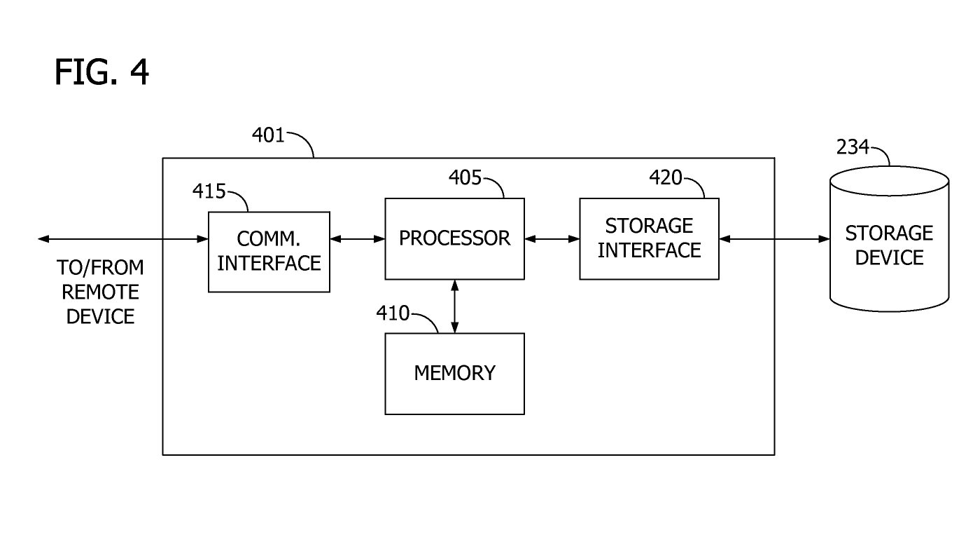

FIG. 4 illustrates an example configuration of a server system 401 of payment network 120 (shown in FIG. 1). Server system 401 may also include, but is not limited to, database server 216, application server 224, web server 226, user authentication server 228, directory server 230, and mail server 232 (shown in FIG. 2). In the example embodiment, server system 401 determines and analyzes characteristics of devices used in payment transactions, as described below.

Server system 401 includes a processor 405 for executing instructions. Instructions may be stored in a memory 410, for example. Processor 405 may include one or more processing units (e.g., in a multi-core configuration) for executing instructions. The instructions may be executed within a variety of different operating systems on the server system 401, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 is operatively coupled to a communication interface 415 such that server system 401 is capable of communicating with a remote device such as a user system or another server system 401. For example, communication interface 415 may receive requests from client system 214 via the Internet, as illustrated in FIG. 2.

Processor 405 may also be operatively coupled to a storage device 234. Storage device 234 is any computer-operated hardware suitable for storing and/or retrieving data. In some embodiments, storage device 234 is integrated in server system 401. For example, server system 401 may include one or more hard disk drives as storage device 234. In other embodiments, storage device 234 is external to server system 401 and may be accessed by a plurality of server systems 401. For example, storage device 234 may include multiple storage units such as hard disks or solid state disks in a redundant array of inexpensive disks (RAID) configuration. Storage device 234 may include a storage area network (SAN) and/or a network attached storage (NAS) system. Storage device 234 may include a cloud-based storage.

In some embodiments, processor 405 is operatively coupled to storage device 234 via a storage interface 420. Storage interface 420 is any component capable of providing processor 405 with access to storage device 234. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 234.

Memory 410 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are for example only, and are thus not limiting as to the types of memory usable for storage of a computer program.

Accordingly, server system 401 is configured to interact with user computing device 302 (shown in FIG. 3). More specifically, the account information application described herein is used by user computing device 302 to provide cardholder account information to server system 401 and thereby facilitate a transaction.

Referring to FIG. 5, in some examples, a taxpayer 500, such as cardholder 122, conducts a plurality of payment transactions with a plurality of merchants 124 (both shown in FIG. 1) located in different merchant locations over a period of time. To facilitate summarizing the payment transactions over the period of time, taxpayer 500 sends a registration request message 502 which includes payment card identifier 504 such as, for example, cardholder account information associated with taxpayer 500 to register or “opt-in” with a reporting service 506 of server system 401 (shown in FIG. 4). Processor 405 is configured to receive registration request message 502 from taxpayer 500. As described herein, processor 405 (shown in FIG. 4) is configured to generate a travel report 508 through reporting service 506. Travel report 508 is based at least on transaction data 507 associated with payment transactions among taxpayers 500 and the plurality of merchants 124. Moreover, as described herein, since taxpayer 500 registered or opted-in with reporting service 506, processor 405 is configured to provide travel report 508 to taxpayer 500. Travel reporting service 506 is not configured to provide any transaction data associated with payment transactions and/or associated travel reports 508 to any government taxing entity.

In the example embodiment, taxpayer 500 conducts payment transactions with a first merchant 510 located in a first merchant location 512 during a first period of time. In some examples, during the first period of time, taxpayer 500 may conduct a plurality of payment transactions with a plurality of first merchants 510 located in a plurality of first merchant locations 512 within a single geographic entity, such as a city or a state. For example, while on a business trip, taxpayer 500 travels to New York City, N.Y. and conducts payment transactions from September 1 to September 5 of a given year with the plurality of first merchants 510. First merchants 510 provide first transaction data 514 to server system 401. First transaction data 514 includes merchant location data 516 and a transaction date 518. In the example embodiment, merchant location data 516 is associated with a merchant zip code of each first merchant 510 and transaction date 518 is associated with the particular date of payment transaction associated with each first merchant 510. Processor 405 is configured to receive first transaction data 514 and memory 410 (shown in FIG. 4) is configured to store first transaction data 514.

During a second period of time, taxpayer 500 conducts payment transactions with a second merchant 520 located at a second merchant location 522 that is different than first merchant location 512. In some examples, during the second period of time, taxpayer 500 may conduct a plurality of payment transactions with a plurality of second merchants 520 located within a single geographical entity such as a city or a state. For example, while on a business trip, taxpayer 500 travels to St. Louis, Mo. and conducts payment transactions from October 1 to October 5 of the given year with the plurality of second merchants 520.

Second merchants 520 provide second transaction data 524 to server system 401. Second transaction data 524 includes merchant location data 516 and transaction date 518. In the example embodiment, merchant location data 516 is associated with a merchant zip code of each second merchant 520 and transaction date 518 is associated with the particular date of payment transaction with each second merchant 520. Processor 405 is configured to receive second transaction data 524 and memory 410 is configured to store second transaction data 524.

During a third period of time, taxpayer 500 conducts payment transactions with a third merchant 526 located at a third merchant location 528 that is different from the first merchant location 512 and the second merchant location 522. In some examples, during the third period of time, taxpayer 500 may conduct a plurality of payment transactions with a plurality of third merchants 526 located in a plurality of third merchant locations 528 within a single geographical entity such as a state or a city. For example, while on a personal trip, taxpayer 500 travels to Los Angeles, Calif. and conducts payment transactions from November 1 to November 5 of the given year with the plurality of third merchants 526.

Third merchants 526 provide third transaction data 530 to server system 401. Third transaction data 530 includes merchant location data 516 and transaction date 518. In the example embodiment, merchant location data 516 is associated with a merchant zip code of each third merchant 526 and transaction date 518 is associated with the particular date of payment transaction with each third merchant 526. Processor 405 is configured to receive third transaction data 530 and memory 410 is configured to store third transaction data 530. In some embodiments, first transaction data 514, second transaction data 524, and third transaction data 530 may include information relating to airlines, hotels, and other travel related expenses.

Memory 410 is configured to store a plurality of tax zones 531 and respective government tax rates associated with the plurality of tax zones 531. More particularly, memory 410 is configured to store tax zone location data for the plurality of tax zones 531. Each of the plurality of tax zones 531 is associated with at least one of a zip code, a city, and a state and/or country associated with merchant 124. In some examples, memory 410 is configured to store a plurality of registered taxpayers 532 associated with cardholders 122. Memory 410 is configured to store taxpayer data such as cardholder account information for the plurality of registered taxpayers 532 associated with cardholders 122. Processor 405 is configured to retrieve a taxpayer identifier 533 associated with each taxpayer 500 from memory 410. Moreover, processor 405 is configured to determine whether a particular taxpayer 500 is one of the plurality of registered taxpayers 532 based on taxpayer identifier 533. In the example embodiment, processor 405 is configured to retrieve transaction data 507 for payment card identifier 504 when taxpayer 500 is one of the plurality of registered taxpayers 532.

In the example embodiment, taxpayers 500 provide a travel report request message 534 which includes payment card identifier 504 associated with taxpayer 500 to server system 401. Travel report request message 534 may also include an account identifier (e.g., a PAN). Travel report request message 534 includes a report date 536 such as a specific period of time, for example, a month within a given year. If taxpayer 500 has registered or opted-in with reporting service 506 of server system 401, processor 405 is configured to receive travel report request message 534 having report date 536 and payment card identifier 504 associated with taxpayer 500.

Processor 405 is configured to retrieve transaction data 507 from memory 410 for a payment card associated with payment card identifier 504 and for a specified report date 536 (e.g., a particular month) based on at least information contained in travel report request message 534. Transaction data 507 includes merchant location data 516 associated with merchant zip code. For example, processor 405 is configured to retrieve transaction data 507 based on a requested report date 536. More particularly, if report date 536 includes a particular date such as (e.g. September 1), processor 405 is configured to retrieve from memory 410 first transaction data 514 of transaction data 507 associated with report date 536. Processor 405 is configured to provide an inferred location 538 of taxpayer 500 using at least merchant zip code and report date 536. More particularly, processor 405 is configured to infer or determine a time and a location associated with each payment transaction. Moreover, processor 405 is configured to infer or determine inferred location 538 of taxpayer 500 for each day of report data 536 using at least the time and location of each payment transaction.

Processor 405 is configured to compare inferred location 538 with the plurality of tax zones 531 stored in memory 410. In the example embodiment, processor 405 is configured to determine a specific tax zone of the plurality of tax zones 531 associated with the inferred location 538 of taxpayer 500 for each day of report date 536. Based on the comparison, processor 405 is configured to associate a selected tax zone of the plurality of tax zones 531 with inferred location 538.

Moreover, processor 405 is configured to provide a travel report 508 to taxpayer 500. Travel report 508 includes inferred locations 538 of taxpayer 500 for each day of report date 536 and tax zones 531 associated with inferred locations 538. Although it is contemplated, processor 405 is not configured to provide travel report 508 directly to a government taxing entity. In some examples, memory 410 is configured to store travel report 508. Alternatively, travel report 508 can be stored on local data repository and/or can be stored on a cloud-based storage.

In the example embodiments, processor 405 is configured to provide taxpayer 500 with one or more options to control how information is portrayed (e.g., in a color calendar, list, graphical representations) on travel report 508. In some examples, travel report 508 may be a calendar with color highlighting to indicate days spent in various tax zones, where each color represents a different tax zone 531. Travel report 508 may also include values representing the total number of days spent in each tax zone 531 during a requested report period.

In the example embodiment, processor 405 is configured to determine whether inferred locations 538 are associated with business travel or personal travel. Processor 405 may determine inferred location 538 as being associated with personal travel or business travel based on the type of card involved in each transaction (e.g., personal card or a corporate card). Processor 405 may also infer the location as being associated with business travel or personal travel based on information such as, but not limited to, the type of merchant involved in each payment transaction and the location of merchants involved in each transaction (e.g., relative to the taxpayers home location). In some examples, a processor 405 may determine the inferred location 538 as being associated with business travel for transactions involving the corporate card. Processor 405 may also determine the inferred location 538 as being associated with business travel for transactions involving a merchant located away from the taxpayer's home, or when the merchant includes a hotel, an airport, restaurant, or other similar merchant type. For transactions involving a personal card, a transaction involving merchants located near the taxpayers home, or a transaction involving merchant types usually associated with vacation travel (e.g., casinos, resorts), the processor 405 may determine the inferred location 538 as being associated with personal travel.

In another example, if report date 536 includes a range of dates, for example, September 1 to November 5, processor 405 is configured to retrieve from memory 410 transaction data 507 associated with the range of dates, for example, first transaction data 514, second transaction data 524 and third transaction data 530. Processor 405 is configured to determine whether inferred locations 538 are associated with business travel or personal travel. More particularly, processor 405 is configured to infer or determine first transaction data 514 and second transaction data 524 are associated with business travel while inferring or determining third transaction data 530 is associated with personal travel.

For the inferred locations 538 of business travel, processor 405 is configured to compare inferred locations 538 with the plurality of tax zones 531 stored in memory 410. In the example embodiment, the processor 405 is configured to determine a specific tax zone or the plurality of tax zone 531 associated with inferred locations 538 of taxpayer 500 based on first transaction data 514 and second transaction data 524. Moreover, processor 405 is configured to generate and provide travel report 508 to taxpayer 500 based on first transaction data 514 and second transaction data 524. Travel report 508 includes the inferred locations 538 of taxpayer 500 for report date 536 and tax zones 531 associated with inferred locations 538 during the range of particular days. In the example embodiment, processor 305 is configured to generate travel report 508 without third transaction data 530 which is associated with personal travel.

In some examples, server system 401 is configured to infer location of taxpayer 500 through communication with a travel application. More particularly, the travel application is configured to receive a plurality location signals from a global positioning satellite system during a period of time. The travel application is configured to store location signals associated with locations of taxpayer 500 during the period of time. In the example embodiment, the travel application is configured to store travel history data associated with the actual locations of taxpayer 500, during the period of time, as received by global positioning system.

The travel application is configured to provide global positioning system locations of taxpayer 500 during the period of time to server system 401. Alternatively, the travel application is configured to provide travel history data during the period of time to server system 401. Server system 401 is configured to receive individual global positioning system locations of taxpayer 500. Processor 405 is configured to validate inferred locations 538 of taxpayer 500 using actual locations and/or travel history data from the travel application. In the example embodiment, the travel application is configured to store validated actual locations and/or travel history data for future referencing and/or tax preparation purposes by taxpayer 500.

In other embodiments, the travel application is configured to receive supplemental data from taxpayer 500. Supplemental data may include, but is not limited to, additional transactions that occurred during travel. For example, taxpayer 500 may enter additional transactions where taxpayer 500 paid with cash, check, or a different payment card. In these other embodiments, the travel application is configured to utilize this supplemental data in creating the travel report and inferring the location of the taxpayer.

In additional embodiments, the travel application is configured to receive data from taxpayer's social media network. The travel application gathers location data from a check-in or other location identifying action on a social media network and stores that data in memory 410. In these additional embodiments, the travel application is configured to utilize this location data in creating the travel report and inferring the location of the taxpayer.

In the example embodiment, payment network 120 (shown in FIG. 1) includes travel reporting service 506 that provides taxpayer 500 with business-related travel data including a determined number of days spent at various locations through the year that can be used by taxpayer 500 for tax preparation and/or reporting purposes. System 120 includes payment server system 401 that includes a travel reporting component configured to determine the business-related travel data (e.g., merchant locations and transaction dates) from the transaction data of the traveler/cardholder/taxpayer, and compares the determined locations to a list of tax zones 531 stored within the system, wherein each tax zone is associated with a government tax rate.

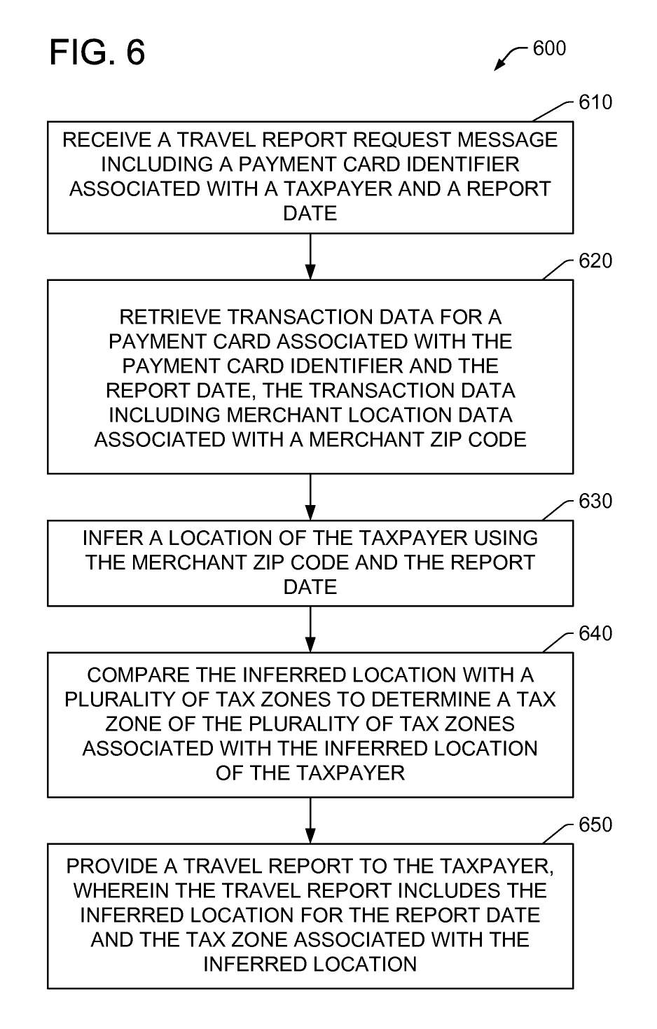

FIG. 6 is a simplified diagram of an example method 600 for inferring taxpayer location 538 (shown in FIG. 5) from transaction data (shown in FIG. 5) by server system 401 (shown in FIG. 4) to facilitate providing travel report 540 (shown in FIG. 5). Method 600 is executed by server system 401 and includes receiving 610 a travel report request message having a payment card identifier associated with the taxpayer and a report date. Receiving 610 represents server system 401 receiving a request such as travel report request message 502 from taxpayer 500 (all shown in FIG. 5), travel report request message 502 includes payment card identifier 504 associated with taxpayer 500 and report date 536 (all shown in FIG. 5).

Server system 401 is also configured to retrieve 620 the transaction data for a payment card associated with the payment card identifier and the report date. Retrieving 620 represents retrieving transaction data 507 (shown in FIG. 5) for the payment card associated with payment card identifier 504 and report date 536, wherein transaction data 507 includes merchant location data 516 (all shown in FIG. 5) associated with a merchant zip code.

Server system 401 is also configured to infer 630 a location of the taxpayer using the merchant zip code and the report date. Inferring 630 represents inferring taxpayer location 538 (shown in FIG. 5) using merchant zip code (shown in FIG. 5) and report date 536 (shown in FIG. 5).

Server system 401 is additionally configured to compare 640 the inferred location with a plurality of tax zones to determine a tax zone of the plurality of tax zones associated with the inferred location of the taxpayer. Comparing 640 represents comparing inferred location 538 (shown in FIG. 5) with the plurality of tax zones 531 (shown in FIG. 5) to determine the tax zone of the plurality of tax zones 531 associated with inferred location 538 (shown in FIG. 5) of taxpayer 500 (shown in FIG. 5).

Server system 401 is also configured to provide 650 the travel report to the taxpayer, wherein the travel report includes the inferred location for the report date and the tax zone associated with the inferred location. Providing 650 represents providing travel report 508 (shown in FIG. 5) to taxpayer 500 (shown in FIG. 5), wherein travel report 508 includes inferred location 538 (shown in FIG. 5) for report date 536 and tax zone 531 associated with inferred location 538 (all shown in FIG. 5).

FIG. 7 is a diagram 700 of components of one or more example computing devices that may be used in the environment shown in FIG. 2. FIG. 7 further shows a configuration of databases including at least database 701. Database 701 is coupled to several separate components within server system 401, which perform specific tasks.

Server system 401 includes a first receiving component 702 for receiving a travel report request message including a payment card identifier associated with a taxpayer and a report date. Server system 401 also includes a retrieving component 704 for retrieving transaction data for a payment card associated with the payment card identifier and the report date, the transaction data including merchant location data associated with a merchant zip code. Server system 401 also includes an inferring component 706 for inferring a location of the taxpayer using the merchant zip code and the report date. Server system 401 additionally includes a comparing component 708 for comparing the inferred location with a plurality of tax zones to determine a tax zone of the plurality of tax zones associated with the inferred location of the taxpayer. Server system 401 further includes a providing component 710 for providing a travel report to the taxpayer, wherein the travel report includes the inferred location for the report date and the tax zone associated with the inferred location.

In an example embodiment, database 701 is divided into a plurality of sections, including but not limited to, payment transaction section 712, a travel report section 714, and a security and encryption section 716. These sections within database 701 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for inferring a taxpayer location from transaction data, said method implemented using a computing device in communication with a memory, said method comprising:
receiving, by the computing device, a travel report request message including a payment card identifier associated with a taxpayer and a report date;
retrieving, by the computing device, transaction data for a payment card associated with the payment card identifier and the report date, the transaction data including merchant location data associated with a merchant zip code;
inferring a location of the taxpayer using the merchant location and the report date;
comparing the inferred location with a plurality of tax zones stored in the memory to determine a specific tax zone of the plurality of tax zones associated with the inferred location of the taxpayer; and
providing a travel report to the taxpayer, wherein the travel report includes the inferred location for the report date and the tax zone associated with the inferred location.

2. The method of claim 1, further comprising receiving, by the computing device, a registration request message including the payment card identifier associated with the taxpayer.

3. The method of claim 1, further comprising storing the travel report on at least one of a local data repository and a cloud-based storage.

4. The method of claim 1, further comprising storing tax zone location data for the plurality of tax zones within the memory, wherein each of the plurality of tax zones is associated with at least one of a zip code, a city, and a country associated with a merchant.

5. The method of claim 1, further comprising determining a travel type associated with the inferred location, wherein the travel type is at least one of a personal travel and a business travel.

6. The method of claim 1, wherein providing a travel report further comprises including a travel type associated with the inferred location.

7. The method of claim 1, further comprising gathering supplemental travel data not included in transaction data.

8. The method of claim 7, further comprising receiving, by the computing device, a global positioning system location of the taxpayer from the mobile computing device.

9. The method of claim 7, further comprising gathering location data associated with the taxpayer from a social media network.

10. The method of claim 7, further comprising receiving, by the computing device, a travel history data from the travel application, wherein the travel history data include data associated with an actual location of the taxpayer.

11. The method of claim 10, further comprising validating the inferred location of the taxpayer using the actual location.

12. A computing device used to infer a taxpayer location from transaction data, said method implemented using the computing device in communication with a memory, the computing device comprising:
a processor; and
a memory coupled to said processor, said processor configured to:
receive a travel report request message including a payment card identifier associated with a taxpayer and a report date;
retrieve transaction data for a payment card associated with the payment card identifier and the report date, the transaction data including merchant location data associated with a merchant zip code;
infer a location of the taxpayer using the merchant location and the report date;
compare the inferred location with a plurality of tax zones stored in said memory to determine a specific tax zone of the plurality of tax zones associated with the inferred location of the taxpayer; and
provide a travel report to the taxpayer, wherein the travel report includes the inferred location for the report date and the tax zone associated with the inferred location.

13. A computing device in accordance with claim 12, wherein said the processor is further configured to store the transaction data within the said memory.

14. A computing device in accordance with claim 12, wherein said processor is further configured to store taxpayer data for a plurality of taxpayers within said memory.

15. A computing device in accordance with claim 14, wherein said processor is further configured to retrieve a taxpayer identifier associated with the taxpayer and determine whether the taxpayer is one of the plurality of registered taxpayers based on the taxpayer identifier.

16. A computing device in accordance with claim 15, wherein said processor is further configured to retrieve the transaction data for a payment card associated with the payment card identifier and the report date when the taxpayer is one of the plurality of registered taxpayers.

17. Computer-readable storage media for inferring a taxpayer location from transaction data, the computer-readable storage media having computer-executable instructions embodied thereon, wherein, when executed by at least one processor, the computer-executable instructions cause the processor to:
receive a travel report request message including a payment card identifier associated with a taxpayer and a report date;
retrieve transaction data for a payment card associated with the payment card identifier and the report date, the transaction data including merchant location data associated with a merchant zip code;
infer a location of the taxpayer using the merchant location and the report date;
compare the inferred location with a plurality of tax zones to determine a specific tax zone of the plurality of tax zones associated with the inferred location of the taxpayer; and
provide a travel report to the taxpayer, wherein the travel report includes the inferred location for the report date and the tax zone associated with the inferred location.

18. The computer-readable storage media in accordance with claim 17, wherein the computer-executable instructions cause the processor to receive a registration request message including a payment card identifier associated with the taxpayer.

19. The computer-readable storage media in accordance with claim 17, wherein the computer-executable instructions cause the processor to store tax zone location data for a plurality of tax zones within a memory, wherein each of the plurality of tax zones is associated with at least one of zip code, a city, and a country associated with a merchant.

20. The computer-readable storage media in accordance with claim 17, wherein the computer-executable instructions cause the processor to determine a travel type associated with the inferred location, wherein the travel type is at least one of a personal travel and a business travel.
